(19) United States
(12) Patent Application Publication
(10) Pub. No.: US 2004/0000329 A1
(43) Pub. Date: Jan. 1, 2004

(54) Compositions and methods for paint overspray removal processes

(76) Inventors: Michael L. Albu, Troy, MI (US); Phillip J. Beauchamp, Roseville, MI (US); Nang T. Bui, Sterling Heights, MI (US)

Correspondence Address: PPG INDUSTRIES, INC., Intellectual Property Department, One PPG Place, Pittsburgh, PA, 15272, US

(21) Appl. No.: 10/455,121

(22) Filed: Jun. 5, 2003

Related U.S. Application Data
(63) Continuation-in-part of application No. 09/916,104, filed on Jul. 26, 2001.

(51) Int. Cl. B08B 7/00

(52) U.S. Cl. 134/38

(57) ABSTRACT

A composition and method for treating oversprayed paints in paint spray booths is provided. The method includes contacting the paint overspray with a wash water system comprising an agitated solution including a coagulant so as to collect the paint overspray in the agitated solution. The solution containing the paint overspray is passed to an area relatively free of agitation so as to cause the solution to spontaneously phase separate into an organic phase containing paint overspray and an aqueous phase. The organic phase containing the paint overspray, which contains the paint solids portion, that includes organic resins and, optionally, pigments, and, optionally, an organic solvents portion, is separated from the aqueous phase. The wash water system for treating paint overspray in paint spray booths includes a coagulant in an amount effective in precipitating the paint solids and, optionally, organic solvents, from the system.

### CROSS-REFERENCE TO RELATED APPLICATION

This application is a continuation-in-part of co-pending U.S. patent application Ser. No. 09/916,104, filed Jul., 26, 2001, entitled “Compositions Incorporating Chitosan for Paint Detackification”.

### FIELD OF THE INVENTION

The present invention relates to compositions and methods for paint overspray removal processes.

### BACKGROUND OF THE INVENTION

Automatic spraying techniques have long been employed for painting large articles such as cars, trucks, refrigerators, etc. The items being sprayed are generally advanced along a conveyor line that passes through a water wash paint spray booth where a fine spray of paint is directed at the articles being painted from spray guns that are located at the sides of the conveyor. Overspray paint, that is, paint that does not contact the article being painted, forms a fine mist of paint in the air space surrounding the painted article. This paint mist must be removed from the air. To accomplish this, the contaminated air is pulled through the paint spray booth by air exhaust fans. A curtain of circulating water is maintained across the path of the air in a manner such that the air must pass through the water curtain to reach the exhaust fans. As the air passes through the water curtain, the paint mist is “scrubbed” from the air and carried to a sump basin usually located below the paint spray booth. In this area, the paint particles are separated from the water so that the water may be recycled and the paint particles disposed of.

Paint is a tacky material and it tends to coagulate and adhere to the spray booth surfaces, particularly in the sump and drain areas, and must constantly be removed from the sump to prevent clogging of the sump drain and recirculating system. In order to assist in the removal of the oversprayed paint from the air and to provide efficient operation of paint spray booths, detackifying agents are commonly employed in the water used in such systems, and are typically incorporated into the water wash recirculated in the paint spray system. Detackifying the paint eliminates or minimizes the adhesive properties, or tackiness, of the paint, thereby preventing the oversprayed paint from adhering to the walls of the spray booth.

One of the difficulties with recovering paint overspray in a water wash spray booth as described above is the limited amount of paint that can be incorporated into the water. As such, detackifying agents should have a high load capacity, such that the water wash recirculated through the spray booth can detackify, coagulate and flocculate a high volume of oversprayed paint before exhaustion.

In recent years, the need to reduce solvent emission has resulted in the reduction of solvent-based or solventborne paints, and an increase in the use of water-based or waterborne paints. Because the hydrophilic properties of the waterborne coating compositions render such compositions readily dispersible or soluble in water, removal of paint solids comprised of components such as organic resins, pigments, and organic solvents, from waterborne paint overspray typically requires the use of different detackifying processes in paint spray booths when compared to solvent-based paints.

For example, it is known to use cationic polymers, such as acrylamide polymers, for detackifying paint and improving paint spray booth efficiency. Materials such as sodium aluminate are typically used to adjust the pH of the water wash system. It is also known to use an organic solvent, such as N-methyl pyrrolidone, to scrub the paint overspray from the surrounding air. However, the use of high quantities of organic solvent needed for this process is expensive and can pose a potential health and environmental hazard. In addition, such detackifying agents are not effective for detackifying both water-based and solvent-based paints.

It is also known to remove and recover solvent-based paint overspray through contact with an agitated dispersion of an organic solvent in water, and then to allow the dispersion to phase separate, that is, to separate the organic phase from the aqueous phase. Such dispersion, however, is often difficult to separate for removal of the paint from the water.

It is also known that in detackifying both waterborne and solvent enamels, a composition that includes a melamine-formaldehyde polymer, a polyvinyl alcohol and a styrene acrylate copolymer may be used. Such materials, however, are not readily biodegradable, and therefore can pose environmental concerns for disposal.

Accordingly, further improvements would be a welcome addition to the art, wherein compositions and methods useful for removal of paint overspray from both waterborne and solvent-based paints are employed to effectively decrease the amount of one or more of organic resins, pigments, and organic solvents in paint spray booths.

### SUMMARY OF THE INVENTION

The present invention includes methods and compositions for treating oversprayed paints containing a paint solids portion and, optionally, an organic solvents portion, the paint solids portion including organic resins and, optionally, pigments. The method includes contacting the paint overspray with a wash water system comprising an agitated solution including a coagulant so as to collect the paint overspray in the agitated solution. The solution containing the paint overspray is passed to an area relatively free of agitation so as to cause the solution to spontaneously phase separate into an organic phase containing paint overspray and an aqueous phase. The organic phase containing the paint overspray, which contains the paint solids portion, that includes organic resins and, optionally, pigments, and, optionally, an organic solvents portion, is separated from the aqueous phase.

In another embodiment of the present invention the method for treating overspray paints is similar to the method described immediately above, and further includes treating the organic phase to separate at least a portion of the paint solids from the organic solvent portion, dispersing the organic solvent portion with the agitated solution for subsequent contact with the paint overspray, and recovering the paint solids.

The present also provides a wash water system for treating paint overspray in paint spray booths, the paint overspray containing a paint solids portion and, optionally, an organic solvents portion, the paint solids portion including organic resins and, optionally, pigments, the wash water system including a coagulant in an amount effective in precipitating the paint solids and, optionally, organic solvents, from the system.

In another embodiment, the present invention provides a wash water system for treating paint overspray in paint spray booths, the system including a coagulant in amounts ranging from 0.005 to 1.0 percent by weight, based on the total weight of the system, an agitated organic solvents component, and water.

### DETAILED DESCRIPTION OF THE INVENTION

Other than in the operating examples, or where otherwise indicated, all numbers expressing quantities of ingredients, reaction conditions and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical values, however, inherently contain certain errors necessarily resulting from the standard deviation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

Any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

The term “paint” as used herein is intended to encompass a mixture of resin and, optionally, pigment, and a suitable liquid vehicle that is reasonably fluid and provides a thin and adherent coating when applied to a substrate. As such, the term “paint” is intended to encompass paints, lacquers, varnishes, base coats, clear coats, primers and the like. The term “overspray paint” is intended to include both waterborne and solvent-based paints.

The term “coagulant”, as use herein refers to a substance that is used in precipitating solids or semi-solids from solution, as polymeric particles from latex, or impurities from water.

The term “wash water”, as used herein, refers to a curtain of circulating water in a paint spray booth, the circulating water being maintained is pulled through the water curtain by exhaust fans, whereby at least a portion of paint mist is “scrubbed” from the air and carried away for further processing.

The term “polymer”, as used herein, is meant to refer to oligomers and both homopolymers and copolymers.

As noted, the composition of the present invention includes an aqueous solution of a coagulant that is employed to remove paint overspray in paint spray booths. The paint overspray may contain a paint solids portion and, optionally, an organic solvents portion, the paint solids portion including organic resins and, optionally, pigments. The agitated solution of a coagulant in water acts to demulsify the paint overspray in the agitated solution.

The coagulant of the present invention may be any material and/or mixture of materials effective in precipitating paint solids and, optionally, organic solvents from solution. Non-limiting examples of suitable coagulants that may be employed in the present invention include:

1) a dialkylaminoalkyl (meth)acrylate polymer;

2) a hexosan polymer;

3) a montmorillonite-containing clay;

4) chitosan;

5) a poly[oxyalkylene(dialkylimino)alkylene] polymer solution;

6) a epihalohydrin/dialkylamine polymer;

7) a polydiallydialkylammonium halide polymer;

8) a polyepiamine;

9) an electrolyte/dialkylamine epihalohydrin; and

10) a halide/dialkylamine-epihalohydrin-alkylenediamine polymer;

and mixtures thereof.

It should be noted that any of the above-mentioned coagulants may further include a complex metal salt (as described below). Also, the montmorillonite-containing clay can be used in conjunction with a polymer such as an acrylic polymer, as described below

The coagulant composition may be ionic (i.e. anionic or cationic), or nonionic. In some embodiments of the present invention, discussed, hereinbelow, the coagulant comprises a cationic aqueous coagulant solution.

The coagulant of the present invention may include an aqueous solution of a dialkylaminoalkyl (meth)acrylate polymer that, in combination with other components such as a complex metal salt, described below, has been found to provide good dispersion properties to paint overspray coagulant solutions. Suitable examples of dialkylaminoalkyl (meth)acrylate polymers suitable for use in the present invention are dimethylaminoethyl methacrylate (CH₂:C(CH₃)COOCH₂—N(CH₃)₂), and the like. In this embodiment, the dialkylaminoalkyl (meth)acrylate polymer may be present in the wash water system in an amount of from 0.005 to 1.0 percent by weight (50 to 10,000 ppm), and more specifically may be present in an amount of from 0.05 to 0.2 percent by weight (500 to 2000 ppm), based on the total weight of the wash water system. For purposes of the present invention, the term “(meth)acrylic” and terms derived therefrom are intended to include acrylic and methacrylic acid and derivatives thereof.

The dialkylaminoalkyl (meth)acrylate polymer coagulant solution of the present invention may further include a complex metal salt, which is capable of flocculating the oversprayed paint. The complex metal salt may be any complex metal salt that is capable of coagulating and flocculating paint. Non-limiting examples of useful complex metal salts include those selected from the group consisting of aluminum chlorohydrate, aluminum sulfate (alum), zinc chloride, ferric chloride, calcium chloride, magnesium hydroxide, and mixtures thereof.

The dialkylaminoalkyl (meth)acrylate coagulant solution of the present invention may include a complex metal salt dissolved therein. The complex metal salt may be dissolved in the coagulant solution in an amount that is greater than the amount of the aqueous solution of dialkylaminoethyl (meth)acrylate polymer, based on the total weight of the coagulant solution. The complex metal salt may be provided in the coagulant solution in an amount of from 2 to 40 percent by weight, and more particularly of from 10 to 15 percent by weight, based on the total weight of the coagulant solution.

In another embodiment of the present invention, the coagulant may include an aqueous solution of a hexosan polymer (i.e. a polymer of glucose), such as an amylopectin polymer, and, optionally, a complex metal salt as described above. Amylopectin is the outer, most insoluble portion of starch granules, in the form of potato starch, and is a branched molecule of many glucose units that forms a paste in water.

The aqueous solution of hexosan may be provided as a mixture of amylopectin, optionally, a complex metal salt, and water. The hexosan polymer may be present in the wash water system in an amount of from 0.005 to 1.0 percent by weight (50 to 10,000 ppm), and more specifically may be present in an amount of from 0.05 to 0.2 percent by weight (500 to 2000 ppm), based on the total weight of the wash water system.

The hexosan composition of the present invention may include a complex metal salt dissolved therein. The complex metal salt may be dissolved in the coagulant solution in an amount that is greater than the amount of the aqueous solution of hexosan polymer, based on the total weight of the coagulant solution. The complex metal salt may be provided in the coagulant solution in an amount of from 2 to 40 percent by weight, and more particularly of from 10 to 15 percent by weight, based on the total weight of the coagulant solution. The complex metal salt may be any complex metal salt described above, and mixtures thereof.

In another embodiment of the present invention, the coagulant may include a montmorillonite-containing clay and, optionally, a water dispersible polymer, such as an acrylic polymer. If present, the polymer may be provided in an amount of from 0.01 to 1.0 percent by weight, based on the total weight of the coagulant solution.

Suitable montmorillonite clays include bentonite, sodium montmorillonite, calcium montmorillonite and/or magnesium montmorillonite; nontronite; biedellite; volkonskonite; hectorite; saponite; sauconite; sobockite; stevensite; svinfordite; vermiculite and the like. In one embodiment of the present invention, the coagulant solution comprises a bentonite clay. When such a clay is employed, the clay may be present in the coagulant solution in an amount of from 1 to 25 percent, more particularly 5 to 15 percent, and more specifically 5 to 10 percent by weight, based on the total weight of the coagulant solution.

In another embodiment, the present invention may comprise an aqueous solution of a compound having the following structure: and water, and, optionally, a complex metal salt, capable of flocculating the oversprayed paint, as set forth in co-pending U.S. patent application Ser. No. 09/916,104, which is incorporated herein by reference in its entirety. The aqueous solution of the compound identified by structure I above may be an aqueous solution of chitosan, and typically includes a mixture of water, chitosan, and an acid capable of rendering the chitosan soluble in water.

The chitosan may be provided in the aqueous solution as a stock solution for later use in preparation of the coagulant solution of the present invention. The stock solution of chitosan in water may include chitosan in water in an amount of from 0.5 to 5 percent by weight chitosan based on the weight of the stock solution, specifically 0.5 to 3 percent by weight, with amounts of 1 percent by weight typically being employed.

Chitosan is not readily dissolvable in water. Accordingly, various agents can be added to render the chitosan more readily soluble. For example, an acid may be added to the water prior to addition of the chitosan, to provide an acidic aqueous solution for dissolving the chitosan. Examples of useful acids include, acetic acid, sulfuric acid, hydrochloric acid, citric acid, sulfamic acid and mixtures thereof. The acid may be provided in the stock solution in an amount of from about 0.5 to about 5 percent by weight, based on the weight of the stock solution, and, more specifically, may be provided in an amount from about 0.5 to about 3 percent by weight.

The chitosan composition of the present invention may include the complex metal salt dissolved therein. The complex metal salt may be dissolved in the coagulant solution in an amount that is greater than the amount of the aqueous solution of chitosan, based on the total weight of the coagulant solution. The complex metal salt may be any complex metal salt described above, and mixtures thereof. The complex metal salt may be provided in the coagulant solution in an amount of from 2 to 40 percent by weight, and more particularly of from 10 to 15 percent by weight, based on the total weight of the coagulant solution. The chitosan may be provided in the coagulant solution in an amount of from 0.1 to 10 percent by weight, based on the total weight of the composition. The acid may be provided in an amount of from 0.1 to about 10 percent by weight, based on the total weight of the coagulant solution. In one embodiment, the acid and the chitosan are provided in equal amounts, based on the total weight of the coagulant solution.

The aqueous solution of chitosan typically includes a viscosity of from 200 to 3000, and, more specifically, 1000 to 1750 centipoise (cps).

In another embodiment, the coagulant of the present invention may include an aqueous cationic polymer, such as, for example, a poly[oxyalkylene(dialkylimino)alkylene] polymer solution. Suitable examples of poly[oxyalkylene(dialkylimino)alkylene] polymers include poly[oxyethylene(dimethylimino)ethylene] polymers, and the like. In this embodiment, the poly[oxyalkylene(dialkylimino)alkylene] polymer may be provided in the wash water system in an amount of from 0.005 to 1.0 percent by weight (50 to 10,000 ppm), and more specifically may be present in an amount of from 0.05 to 0.2 percent by weight (500 to 2000 ppm), based on the total weight of the wash water system.

In another embodiment of the present invention, the coagulant may include an aqueous solution of a epihalohydrin/dialkylamine polymer. Suitable examples of a epihalohydrin/dialkylamine polymer can include epichlorohydrin/dimethylamine polymers (EPI/DMA), and the like. In this embodiment, the epihalohydrin/dialkylamine polymer polymer may be present in the wash water system in an amount of from 0.005 to 1.0 percent by weight (50 to 10,000 ppm), and more specifically may be present in an amount of from 0.05 to 0.2 percent by weight (500 to 2000 ppm), based on the total weight of the wash water system.

In another embodiment of the present invention, the coagulant may include an aqueous solution of a polydiallydialkylammonium halide polymer. Suitable examples of a polydiallydialkylammonium halide polymer include polydiallydimethylammonium chloride polymers, and the like. In this embodiment, the polydiallydimethylammonium halide polymer may be present in the wash water system in an amount of from 0.005 to 1.0 percent by weight (50 to 10,000 ppm), and more specifically may be present in an amount of from 0.05 to 0.2 percent by weight (500 to 2000 ppm), based on the total weight of the wash water system.

Another embodiment of the present invention is directed to a coagulant that includes an aqueous solution of a polyepiamine and, optionally, a complex metal salt as described above. The aqueous solution of polyepiamine typically is provided as a mixture of polyepiamine, optionally, a complex metal salt, and water. The polyepiamine may be present in the wash water system in an amount of from 0.005 to 1.0 percent by weight (50 to 10,000 ppm), and more specifically may be present in an amount of from 0.05 to 0.2 percent by weight (500 to 2000 ppm), based on the total weight of the wash water system.

The polyepiamine composition of the present invention may include the complex metal salt dissolved therein. The complex metal salt may be dissolved in the coagulant solution in an amount that is greater than the amount of the aqueous solution of polyepiamine polymer, based on the total weight of the coagulant solution. The complex metal salt may be provided in the coagulant solution in an amount of from 2 to 40 percent by weight, and more particularly of from 10 to 15 percent by weight, based on the total weight of the coagulant solution. The complex metal salt may be any complex metal salt described above, and mixtures thereof.

In another embodiment of the present invention, the coagulant may include an aqueous solution of an electrolyte/dialkylamine epihalohydrin. Suitable examples of an electrolyte include those electrolytes that provide ionic destabilization of the dispersed paint, and include, for example, sodium chloride, potassium chloride, and magnesium chloride. Suitable examples of the electrolyte/dialkylamine epihalohydrin coagulant of the present invention include sodium chloride/dimethylamine epichlorohydrin, and the like. In this embodiment, the electrolyte/dialkylamine epihalohydrin may be present in the wash water system in an amount of from 0.005 to 1.0 percent by weight (50 to 10,000 ppm), and more specifically may be present in an amount of from 0.05 to 0.2 percent by weight (500 to 2000 ppm), based on the total weight of the wash water system.

In another embodiment of the present invention, the coagulant may include an aqueous solution of a halide/dialkylamine-epihalohydrin-alkylenediamine polymer. Suitable examples of a halide/dialkylamine-epihalohydrin-alkylenediamine polymer include a chloride/dimethylamine-epichlorohydrin-ethylenediamine polymer. In this embodiment, the aqueous solution of halide/dialkylamine-epihalohydrin-alkylenediamine polymer may be present in the wash water system in an amount of from 0.005 to 1.0 percent by weight (50 to 10,000 ppm), and more specifically may be present in an amount of from 0.05 to 0.2 percent by weight (500 to 2000 ppm), based on the total weight of the wash water system.

It is contemplated that the embodiments of the aqueous coagulant solutions of the present invention, set forth above, may be employed alone or in combination in the wash water of the paint overspray removal process of the present invention. For example, two or more of the coagulants set forth above may be employed as a coagulant mixture to provide certain cost benefits to the process, or to impart certain property advantages to the process that may not be provided by any one coagulant.

Additionally, other compounds may be included in the composition of the present invention to act as co-flocculants. Useful compounds includeamine group-containing polymers, for example, acrylamide polymers, particularly cationic acrylamide polymers. Examples of useful cationic acrylamide polymers include, but are not limited to, dimethylaminoethylmethacrylate sulfuric acid salt, dimethylaminoethylmethacrylate methyl chloride quaternary ammonium salt, dimethylaminoethylmethacrylate methyl sulfate quaternary ammonium salt, dimethylaminoethylacrylate methyl chloride quaternary ammonium salt, acrylamidopropyltrimethyl ammonium chloride, and mixtures thereof.

The coagulant solution of the present invention is typically prepared by combining the coagulant and water optionally in the presence of an acid, and mixing at a temperature and for a time sufficient to form an aqueous solution of the coagulant.

After formation of the aqueous solution of the coagulant, a portion of this aqueous solution is combined with additional water. The complex metal salt, if present, is then added to the solution, with gentle stirring, to form the coagulant solution of the present invention. Montmorillonite-containing clay, such as bentonite clay may be added to the coagulant solution, if desired.

The aqueous composition of the present invention may be prepared in the form of a liquid concentrate, which is intended for addition to water systems for use in paint spray booths. As such, the composition can be added to a volume of wash water which is recirculated through a paint spray booth as an initial detackifying additive, and also can be added as a maintenance detackifying additive during operation of the paint spray booth, as will be discussed in more detail herein. When used in such water systems, the coagulant solution is typically provided in an amount of from 0.01 to 10 percent of the volume of water recirculated through the system, such as in an amount of from 0.005 to 1.0 percent by weight (50 to 10,000 ppm), and more particularly from 0.05 to 0.2 percent by weight (500 to 2000 ppm), based on the total weight of the wash water system.

The water system including the coagulant solution therein typically is maintained at a pH between 6 to 10, and more particularly between 6.5 and 8.0. Because the coagulant solution of the present invention may, in some embodiments, be slightly acidic, the use of the composition in a recirculating water system may affect the pH of the system. Accordingly, the pH of the water system may be adjusted as is known in the art. For example, small increments of liquid caustic soda, i.e., 50% NaOH, may be added to the water system to maintain the pH in the desired range. Such liquid caustic soda may, for example, be added to the water system in a proportion of 0.05 to 1.5 ml liquid caustic soda per 10 ml of wash water.

As previously mentioned, in accordance with the method of the present invention, oversprayed paint particles in a paint spray booth are treated with a circulating water system including at least one coagulant in aqueous solution, as described above. The coagulant solution of the present invention as discussed above may be added to the wash water system of the paint spray booth in any manner known to those of skill in the art. For example, the coagulant of the present invention may be added directly into the spray booth wash water. The circulating wash water system forms a continuous moving water curtain that scrubs an air flow containing paint overspray so as to collect the paint overspray in the water curtain. Paint spray booths containing continuous curtains of water to scrub air flows containing paint overspray are known in the art, for example U.S. Pat. No. 4,980,030, which discloses typical paint spray booths.

In operation, an object to be painted is placed within the paint spray booth, and is painted using known spray techniques. The overspray paint is contacted with the continuous curtains of water that is pumped through the paint spray booth in known manner. Such contacting of the overspray paint with the wash water system including the coagulant solution of the present invention causes the paint to flocculate and separate from the wash water, thereby forming a sludge layer on/in the wash water system that is circulated through the paint spray booth. In addition, the coagulant solution of the present invention also can detackify the flocculated paint. The amount of the flocculated paint sludge in the water solution is monitored and removed periodically, through known methods. Additionally, as previously discussed, the pH of the wash water system is periodically monitored and readjusted, if necessary.

The effectiveness of the coagulant and/or the detackifying agent is also periodically monitored during operation of the paint spray booth. This may be accomplished by monitoring the tackiness of the paint sludge removed from the paint spray booth. Alternatively, the level of the coagulant and/or detackifying agent may be monitored to maintain a desired predetermined threshold level of these materials within the wash water. When the wash water fails to effectively detackify the oversprayed paint and/or when the level of the coagulant and/or detackifying agent drops below a desired predetermined threshold level, a maintenance dosage of the detackifying agent and/or the coagulant solution of the present invention may be added to the recirculating water, thereby maintaining the effectiveness of the paint spray booth.

The coagulant solution of the present invention is used in a similar manner when used in connection with both waterborne and solvent-based paint denaturant systems. An example of such a system is described in detail in U.S. Pat. No. 5,223,141, the disclosure of which is incorporated herein by reference in its entirety. Such paint denaturant systems may include in the wash water a dispersion of an organic solvent component in water. The coagulant solution of the present invention may be added to the wash water containing such dispersion.

More particularly, the organic solvent component may comprise a single organic solvent or a mixture of organic solvents. Examples of organic solvents useful include alkyl esters of polycarboxylic acids or mixtures of such esters, such as dimethyl adipate, dimethyl glutarate, dimethyl succinate and mixtures thereof; diisobutyl adipate, diisobutyl glutarate, diisobutyl succinate and mixtures thereof.

The organic solvent component that may be used in the method of the invention may have a solubility in water of less than 15 percent, particularly from 1 to 5 percent by weight, and in which the water may be soluble to an extent of less than 15 percent, particularly from 1 to 5 percent by weight; the percentages by weight being based on total weight of water and organic solvent.

Besides the solubility characteristics described above, the organic solvent component may have a specific gravity sufficiently higher or lower than water to facilitate separation of the organic phase from the aqueous phase. Typically, the specific gravity of the organic solvent component is either less than 0.98 or greater than 1.02, particularly from 0.90 to 0.95 or 1.05 to 1.10.

In addition to the solubility and specific gravity properties, the organic solvent component may have a vapor pressure less than 0.1 millimeters of mercury. Low vapor pressures are desirable because less volatile organic content is released to the atmosphere due to evaporation.

As previously mentioned, the organic solvent component (when present) can comprise a single organic solvent or a mixture of organic solvents. Examples of organic solvents which are usable in the method of the invention include alkyl esters of polycarboxylic acids or mixtures of such esters. Typically, these esters are of the following structural formula:

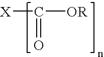

where X is a linear or branched aliphatic group having 2 to 12 carbon atoms or aromatic group having 6 to 20 carbon atoms and R is a linear or branched alkyl group typically containing from about 1 to 8 carbon atoms and n=2 to 4. Substituted aliphatic, aromatic and alkyl groups can be used in which the substituents do not adversely affect the removal and the recovery of the paint overspray components. The alkyl esters also may include dialkyl esters of dibasic carboxylic acids or mixtures of such esters. These esters have the following structural formula:

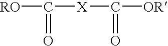

where X is a linear or branched alkylene group containing from 2 to 12, and more particularly 2 to 8 carbon atoms and R and R′ can be the same or different and are linear or branched alkyl containing from 1 to 6, and more particularly from 1 to 4 carbon atoms. Examples of specific alkyl esters of polybasic acids include dimethyl adipate, dimethyl glutarate, dimethyl succinate and mixtures thereof; diisobutyl adipate, diisobutyl glutarate, diisobutyl succinate and mixtures thereof. Mixtures of such esters are available from E. I. Du Pont de Nemours and Company as Dibasic Acid Ester (DBE-3) or Dibasic Acid Diisobutyl Ester (DBE-IB).

Examples of other organic solvents include polyol ethers including mono and diethers of glycols such as mono or dialkyl or mono or diaryl or mixed alkyl and aryl ethers of glycols such as ethylene glycol, diethylene glycol, dipropylene glycol and propanol and mixtures of glycol ethers. Examples of specific polyol ethers include ethylene glycol monobutyl ether, ethylene glycol monophenyl ether, diethylene glycol monobutyl ether, propylene glycol monomethyl ether, propylene glycol monophenyl ether, dipropylene glycol monomethyl ether, dimethylether of ethylene glycol and dimethylether of diethylene glycol. Other examples of organic solvents include furfural and isophorone.

The concentration of the organic solvent component in the aqueous dispersion is typically from 2 to 50, and may be from 15 to 25, and more particularly may be from 2 to 10 percent by weight based on weight of organic solvent component and water.

The organic solvent component can be dispersed into the wash water system by simply adding it to the circulating water in a typical water wash spray booth. The coagulant of the present invention may also be added into the wash water in a similar manner. The pumping and circulation action associated with the spray booth ensures that the organic solvent component will be stably dispersed in the aqueous medium, and ensures that the coagulant will remain properly mixed in the aqueous medium.

The paint overspray typically contains pigments, organic resins and organic solvent associated with industrial paints. Typical paints are acrylic-based paints, urethane-based paints, base coat/clear coat paints and high solids paints which are used in the automotive, appliance and general industrial markets.

As described above, the overspray paint is contacted with the continuous curtain of wash water that is pumped through the paint spray booth in known manner. Such contacting of the overspray paint with the solution that may include the organic solvent in water and the coagulant solution of the present invention collects the overspray paint in the solution.

The solution that contains the paint overspray is pumped through the system in known manner, such as to a sludge tank that is an area relatively free of agitation where the paint sludge (which includes paint solids, and possibly organic solvents) can optionally be removed from the wash water system. The continuous circulation and pumping action keeps the solution agitated and stable.

In order to facilitate additional paint sludge removal, the solution containing the paint sludge can be transferred (as by pumping) to a holding tank that may be relatively free of agitation, where the solution spontaneously phase separates into an organic phase and an aqueous phase. The organic phase that contains most if not all of the paint overspray is separated from the aqueous phase. The inclusion of the aqueous solution of coagulant solution facilitates partial demulsification of the paint overspray from the aqueous phase and imparts a capacity to reduce dispersion of the solvent layer (if present), and decreases the time for phase separation. It is also contemplated that at the holding tank, at least a portion of the aqueous phase from this area may be removed so that the coagulant solution may be added thereto for recirculation to the spray booth.

The organic phase may be further separated into an organic solvent portion and a portion that contains paint solids that comprise organic resin and, optionally, pigment. Typical separating units would be a distillation column, a thin film evaporator or a centrifuge. The organic solvent portion (which contains the organic solvent component initially used to formulate the solution as well as at least a portion of the organic solvent component associated with the paint) is recovered in either the distillate or centrifugate, and may be returned to the recirculating system, where it can be readily dispersed. The paint solids as separated may be reclaimed for further use or may be disposed of. Because the paint is uncured, it can be used as curable filler in adhesives or in paints.

The coagulants of the present invention may be employed in wash water systems to aid in the removal of paint overspray from paint spray booths. The coagulants of the present invention have been found to be particularly useful for removal of waterborne paint overspray from spray booths.

Illustrating the invention are the following examples, which are not to be considered as limiting the invention to their details. All parts and percentages in the examples as well as throughout the specification are by weight unless otherwise indicated.

### EXAMPLES

A number of materials were screened for their effectiveness in facilitating the coagulation of waterborne paint solids, as they exist in an organic solvents component system. In a general procedure, 500 mL of tap water was charged with 2 mL of a waterborne paint mixture and mixed with moderate speed on a laboratory stirring plate. While mixing, up to 2.0 mL of various coagulants were added. The ability to flocculate the paint solids was evaluated for each coagulant. The addition was stopped when flocculation was clearly observed or when the 2.0 mL maximum was achieved. The resultant solution was then mixed and a 5 mL sample withdrawn, then added to an admixture of 90 mL of tap water and 10 mL DBE-IB solvent. The mixture was vigorously hand shaken and allowed to rest for 5 to 10 minutes. After this time observations were made as to sludge solubility, degree of phase separation, sludge volume, and water clarity.

### Example 1

Following the procedure outlined above, two solutions of a dimethylaminoethylacrylate polymer were evaluated. One solution comprised a dimethylaminoethylacrylate polymer and aluminum chlorohydrate salt, commercially available as BCTL2020 from PPG Industries, Inc. The other solution comprised dimethylaminoethylacrylate polymer and an aluminum sulfate salt, commercially available as BCTL8009 from PPG Industries, Inc. Both solutions were observed to yield slight flocculation formation, sludge solubility in the solvent (DBE-IB) layer, a good degree of phase separation, and medium sludge volumes.

### Example 2

A solution of amylopectin combined with an aluminum sulfate salt, commercially available as BCTL2000 from PPG Industries, Inc., was tested using the above procedure. It was observed to produce definite flocculant formation, sludge solubility in the solvent (DBE-IB) layer, good degree of separation of the various solvent phases, and a medium sludge volume.

### Example 3

A coagulant solution comprising an alkylether hydroxypropyl sultaine (MIRATAINE® ASC, commercially available from Rhodia, Inc., Cranberry N.J.) in a DBE-IB solvent, commercially available as BCTL3001 from PPG Industries, Inc., was tested following the above procedure. It was observed to produce slight flocculant formation, no sludge solubility in the solvent layer, good phase separation. No sludge was produced.

### Example 4

Two complex amine carboxylate coagulants, commercially available as BASF MAFO® and BASF MAFO® 13 MOD 1 from BASF Corporation, Mount Olive, N.J., were tested following the above procedure. These materials proved ineffective for flocculant formation and sludge solubility. A slight degree of phase separation was observed.

### Example 5

A cocamidopropyl hydroxysultaine and a cocamidopropyl hydroxybetaine, commerically available as Lonza JS and Lonza CS, respectively, both from Lonza, Inc., Fairlawn N.J., were tested as coagulants using the above procedure. Both proved to be ineffective at flocculant formation and sludge solubility. A slight degree of phase separation was observed for both.

### Example 6

A poly [oxythylene (dimethyliminio) ethylene], commercially available as Recool Add 8 from PPG Industries, Inc., was tested as a coagulant according to the above procedure. The material proved to be very effective at flocculant formation, sludge solubility, and phase separation.

### Example 7

A chitosan coagulant comprising a mixture of an acidic solution of chitosan and an aluminum salt as set forth in copending U.S. patent application Ser. No. 09/916104 was tested according to the above procedure and proved to be very effective at producing flocculant formation, sludge solubility, and phase separation.

### Example 8

Two Polydiallyidimethylammonium chloride compounds, commercially available as Pearl River Polymer 4440 and Pearl River Polymer 4540 from Chemtall, Inc., Riceboro N.J., were tested as coagulants using the above procedure. The compounds proved to be very effective at flocculant formation, sludge solubility, and phase separation.

### Example 9

A number of epichlorohydrin-dimethylamine compounds, including BCTL8005 commercially available from PPG Industries, Inc., and C-572, C-573, C-577, C-581, and C-582 all commercially available from Cytec Industries, Inc., West Paterson, N.J., were tested as coagulants using the above procedure. These materials all proved to be effective at flocculant formation, sludge solubility, and phase separation.

It will also be appreciated by those skilled in the art that changes could be made to the embodiments described above without departing from the broad inventive concept thereof. It is understood, therefore, that this invention is not limited to the particular embodiments disclosed, but it is intended to cover modifications that are within the spirit and scope of the invention, as defined by the appended claims.

What is claimed is:

1. A method for the removal of paint overspray in paint spray booths, the paint overspray containing a paint solids portion and, optionally, an organic solvents portion, the paint solids portion including organic resins and, optionally, pigments, the method comprising:
contacting the paint overspray with a wash water system comprising an agitated solution including a coagulant so as to collect the paint overspray in the agitated solution;
passing the solution containing the paint overspray to an area relatively free of agitation so as to cause the solution to spontaneously phase separate into an organic phase containing paint overspray and an aqueous phase; and
separating the organic phase containing the paint overspray, which contains the paint solids portion, that includes organic resins and, optionally, pigments, and, optionally, an organic solvents portion, from the aqueous phase.

2. The method of claim 1, further comprising treating the organic phase to separate at least a portion of the paint solids from the organic solvent portion.

3. The method of claim 2, further comprising dispersing the organic solvent portion with the agitated solution for subsequent contact with the paint overspray.

4. The method of claim 2, further comprising recovering the paint solids.

5. The method of claim 2, wherein the organic phase is distilled to recover the organic solvent portion in the distillate.

6. The method of claim 2, wherein the organic phase is centrifuged to recover the organic solvent portion in the centrifugate.

7. The method of claim 2, wherein the organic phase is subjected to thin film evaporation to recover the organic solvent portion in the distillate.

8. The method of claim 1, wherein the separated aqueous phase is reused for dispersing the organic solvent component for subsequent contact with the paint overspray.

9. The method of claim 1, further comprising removing at least a portion of the paint overspray from the area relatively free of agitation and adding the coagulant thereto for recirculation to the spray booth.

10. The method of claim 1, wherein the overspray paint is a waterborne paint.

11. The method of claim 1, wherein the coagulant is cationic.

12. The method of claim 1, wherein the coagulant includes a dialkylaminoalkyl (meth)acrylate polymer.

13. The method of claim 12, wherein the coagulant further includes a complex metal salt.

14. The method of claim 13, wherein the complex metal salt is an aluminum salt.

15. The method of claim 13, wherein the complex metal salt is selected from the group consisting of aluminum chlorohydrate, aluminum sulfate, zinc chloride, ferric chloride, calcium chloride, magnesium hydroxide, and mixtures thereof.

16. The method of claim 12, wherein the dialkylaminoalkyl (meth)acrylate polymer is a dimethylaminoethyl methacrylate polymer.

17. The method of claim 1, wherein the coagulant includes a hexosan polymer.

18. The method of claim 17, wherein the coagulant further includes a complex metal salt.

19. The method of claim 18, wherein the complex metal salt is an aluminum salt.

20. The method of claim 18, wherein the complex metal salt is selected from the group consisting of aluminum chlorohydrate, aluminum sulfate, zinc chloride, ferric chloride, calcium chloride, magnesium hydroxide, and mixtures thereof.

21. The method of claim 17, wherein the hexosan polymer is an amylopectin polymer.

22. The method of claim 1, wherein the coagulant includes a montmorillonite-containing clay.

23. The method of claim 22, wherein the coagulant further includes an acrylic polymer.

24. The method of claim 22, wherein the montmorillonite-containing clay is bentonite clay.

25. The method of claim 1, wherein the coagulant includes a poly[oxyalkylene(dialkylimino)alkylene] polymer solution.

26. The method of claim 25, wherein the poly[oxyalkylene(dialkylimino)alkylene] polymer is poly[oxyethylene(dimethylimino)ethylene].

27. The method of claim 1, wherein the coagulant includes an epihalohydrin/dialkylamine polymer solution.

28. The method of claim 27, wherein the epihalohydrin/dialkylamine polymer is an epichlorohydrin/dimethylamine polymer.

29. The method of claim 1, wherein the coagulant includes a polydiallydialkylammonium halide polymer.

30. The method of claim 29, wherein the polydiallydialkylammonium halide polymer is a polydiallydimethylammonium chloride polymer.

31. The method of claim 1, wherein the coagulant includes a polyepiamine.

32. The method of claim 31, wherein the coagulant further include a complex metal salt.

33. The method of claim 32, wherein the complex metal salt is an aluminum salt.

34. The method of claim 32, wherein the complex metal salt is selected from the group consisting of aluminum chlorohydrate, aluminum sulfate, zinc chloride, ferric chloride, calcium chloride, magnesium hydroxide, and mixtures thereof.

35. The method of claim 1, wherein the coagulant includes an electrolyte/dialkylamine epihalohydrin.

36. The method of claim 35, wherein the electrolyte/dialkylamine epihalohydrin is a sodium chloride/dimethylamine epichlorohydrin.

37. The method of claim 1, wherein the coagulant includes a halide/dialkylamine-epihalohydrin-alkylenediamine polymer.

38. The method of claim 37, wherein the halide/dialkylamine-epihalohydrin-alkylenediamine is a chloride/dimethylamine-epichlorohydrin-ethylenediamine polymer.

39. The method of claim 1, wherein the coagulant includes components selected from the group consisting of:
a) a dialkylaminoalkyl (meth)acrylate polymer;
b) a hexosan polymer;
c) a montmorillonite-containing clay;
d) a poly[oxyalkylene(dialkylimino)alkylene] polymer solution;
e) a epihalohydrin/dialkylamine polymer;
f) a polydiallydialkylammonium halide polymer;
g) a polyepiamine;
h) an electrolyte/dialkylamine epihalohydrin; and
i) a halide/dialkylamine-epihalohydrin-alkylenediamine polymer; and
mixtures thereof.

40. The method of claim 39, wherein the coagulant is a mixture of:
1) at least one of a) through i); and
2) chitosan.

41. The method of claim 1, wherein the wash water system further comprises an agitated organic solvents component to form a dispersed solution, the organic solvents component being characterized as having a solubility in water of less than 15 percent by weight and in which water is soluble in the organic solvent component to an extent of less than 15 percent by weight, the percentages by weight being based on weight of organic solvent component and water.

42. The method of claim 41, wherein the dispersed solution is stable in the presence of agitation but unstable in the absence of agitation.

43. The method of claim 41, wherein the organic solvent component has a solubility in water of 1 to 5 percent by weight.

44. The method of claim 41, wherein water has a solubility in the organic solvent component to an extent of 1 to 5 percent by weight.

45. The method of claim 41, wherein the organic solvent component has a vapor pressure less than 0.1 mm mercury.

46. The method of claim 41, wherein the organic solvent component has a specific gravity of 0.90 to 0.95 or 1.05 to 1.10.

47. The method of claim 41, wherein the solution of the organic solvent component in water is agitated by the pumping and circulating action of the solution in a water wash spray booth.

48. The method of claim 41, wherein the organic solvent component is present in the solution in amounts of 2 to 50 percent by weight based on weight of water and organic solvent component.

49. The method of claim 48, wherein the organic solvent component is present in the solution in amounts of 15 to 25 percent by weight based on weight of water and organic solvent component.

50. The method of claim 41, wherein the organic solvent component contains a dialkyl ester of a dibasic acid having the following structure: 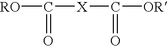
where R and R′ are the same or different and are alkyl groups containing from 1 to 6 carbon atoms, and X is an alkylene group containing from 2 to 12 carbon atoms or a mixture of such esters.

51. The method of claim 50, wherein the dialkyl ester of a dibasic acid is selected from the group consisting of dimethyl adipate, dimethyl glutarate, dimethyl succinate and mixtures thereof.

52. The method of claim 41, wherein the organic solvent component contains a glycol ether or mixture of glycol ethers.

53. A method for the removal of paint overspray in paint spray booths, the paint overspray containing a paint solids portion and, optionally, an organic solvents portion, the paint solids portion including an organic resins and, optionally, pigments, the method comprising:
contacting the paint overspray with a wash water system comprising an agitated solution including a coagulant so as to collect the paint overspray in the agitated solution;
passing the solution containing the paint overspray to an area relatively free of agitation so as to cause the solution to spontaneously phase separate into an organic phase containing paint overspray and an aqueous phase;
separating the organic phase containing the paint overspray, which contains the paint solids portion, that includes organic resins and, optionally, pigments, and, optionally, an organic solvents portion, from the aqueous phase.
treating the organic phase to separate at least a portion of the paint solids from the organic solvent portion.

54. The method of claim 53, further comprising dispersing the organic solvent portion with the agitated solution for subsequent contact with the paint overspray.

55. The method of claim 54, further comprising recovering the paint solids.

56. The method of claim 53, further comprising recirculating the aqueous phase for contact with the paint overspray.

57. The method of claim 53, further comprising removing at least a portion of the paint overspray from the area relatively free of agitation and adding the coagulant thereto for recirculation to the spray booth.

58. The method of claim 53, wherein the paint overspray is a waterborne paint.

59. The method of claim 53, wherein the organic phase is distilled to recover the organic solvent portion in the distillate.

60. The method of claim 53, wherein the organic phase is centrifuged to recover the organic solvent portion in the centrifugate.

61. The method of claim 53, wherein the organic phase is subjected to thin film evaporation to recover the organic solvent portion in the distillate.

62. The method of claim 53, wherein the separated aqueous phase is reused for dispersing the organic solvent component for subsequent contact with the paint overspray.

63. The method of claim 53, wherein the coagulant includes components selected from the group consisting of:
a) a dialkylaminoalkyl (meth)acrylate polymer;
b) a hexosan polymer;
c) a montmorillonite-containing clay;
d) a poly[oxyalkylene(dialkylimino)alkylene] polymer solution;
e) a epihalohydrin/dialkylamine polymer;
f) a polydiallydialkylammonium halide polymer;
g) a polyepiamine;
h) an electrolyte/dialkylamine epihalohydrin; and
i) a halide/dialkylamine-epihalohydrin-alkylenediamine polymer; and
mixtures thereof.

64. The method of claim 53, wherein the coagulant is a mixture of:
1) at least one of a) through i); and
2) chitosan.

65. A wash water system for treating paint overspray in paint spray booths, the paint overspray containing a paint solids portion and, optionally, an organic solvents portion, the paint solids portion including organic resins and, optionally, pigments, the wash water system including a coagulant in an amount effective in precipitating at least a portion of the paint solids and, optionally, organic solvents, from the system.

66. The system of claim 65, wherein the coagulant is provided in amounts ranging from 0.005 to 1.0 percent by weight, based on the total weight of the wash water system.

67. The system of claim 65, wherein the coagulant is provided in amounts ranging from 0.05 to 0.2 percent by weight, based on the total weight of the wash water system.

68. The system of claim 65, wherein the paint overspray is a waterborne paint.

69. The system of claim 65, wherein the coagulant is cationic.

70. The system of claim 65, wherein the coagulant includes a dialkylaminoalkyl (meth)acrylate polymer.

71. The system of claim 70, wherein the coagulant further includes a complex metal salt.

72. The system of claim 71, wherein the complex metal salt is an aluminum salt.

73. The system of claim 71, wherein the complex metal salt is selected from the group consisting of aluminum chlorohydrate, aluminum sulfate, zinc chloride, ferric chloride, calcium chloride, magnesium hydroxide, and mixtures thereof.

74. The system of claim 71, wherein the complex metal salt is provided in an amount of from 2 to 40 percent by weight, based on the total weight of the coagulant solution.

75. The system of claim 70, wherein the dialkylaminoalkyl (meth)acrylate polymer is a dimethylaminoethyl methacrylate polymer.

76. A system of claim 70, wherein the dialkylaminoalkyl (meth)acrylate polymer is provided in an amount of from 0.005 to 1.0 percent by weight, based on the total weight of the wash water system.

77. The system of claim 65, wherein the coagulant includes a hexosan polymer.

78. The system of claim 77, wherein the coagulant further includes a complex metal salt.

79. The system of claim 78, wherein the complex metal salt is an aluminum salt.

80. The system of claim 78, wherein the complex metal salt is selected from the group consisting of aluminum chlorohydrate, aluminum sulfate, zinc chloride, ferric chloride, calcium chloride, magnesium hydroxide, and mixtures thereof.

81. The system of claim 78, wherein the complex metal salt is provided in an amount of from 2 to 40 percent by weight, based on the total weight of the coagulant solution.

82. The system of claim 77, wherein the hexosan polymer is an amylopectin polymer.

83. A system of claim 77, wherein the hexosan polymer is provided in an amount of from 0.005 to about 1.0 percent by weight, based on the total weight of the wash water system.

84. The system of claim 65, wherein the coagulant includes a montmorillonite-containing clay.

85. The system of claim 84, wherein the coagulant further includes an acrylic polymer.

86. The system of claim 84, wherein the montmorillonite-containing clay is bentonite clay.

87. The system of claim 84, wherein the montmorillonite-containing clay is provided in an amount of from 1 to 25 percent by weight, based on the total weight of the coagulant solution.

88. The system of claim 85, wherein the acrylic polymer is provided in an amount of from 0.01 to 1.0 percent by weight, based on the total weight of the coagulant solution.

89. The system of claim 65, wherein the coagulant includes a poly[oxyalkylene(dialkylimino)alkylene] polymer solution.

90. The system of claim 89, wherein the poly[oxyalkylene(dialkylimino)alkylene] polymer solution is a poly[oxyethylene(dimethylimino)ethylene] polymer solution.

91. The system of claim 89, wherein the poly[oxyalkylene(dialkylimino)alkylene] polymer is provided in an amount of from 0.005 to 1.0 percent by weight, based on the total weight of the wash water system.

92. The system of claim 65, wherein the coagulant includes a epihalohydrin/dialkylamine polymer solution.

93. The system of claim 92, wherein the epihalohydrin/dialkylamine polymer is a epichlorohydrin/dimethylamine polymer.

94. The system of claim 92, wherein the epihalohydrin/dialkylamine polymer is provided in an amount of from 0.005 to 1.0 percent by weight, based on the total weight of the wash water system.

95. The system of claim 65, wherein the coagulant includes a polydiallydialkylammonium halide polymer.

96. The system of claim 95, wherein the polydiallydialkylammonium halide polymer is a polydiallydimethylammonium chloride polymer.

97. The system of claim 95, wherein the polydiallydialkylammonium halide polymer is provided in an amount of from 0.005 to 1.0 percent by weight, based on the total weight of the wash water system.

98. The system of claim 65, wherein, the coagulant includes a polyepiamine.

99. The system of claim 98, wherein the coagulant further include a complex metal salt.

100. The system of claim 99, wherein the complex metal salt is selected from the group consisting of aluminum chlorohydrate, aluminum sulfate, zinc chloride, ferric chloride, calcium chloride, magnesium hydroxide, and mixtures thereof.

101. The system of claim 99, wherein the complex metal salt is an aluminum chlorohydrate.

102. The system of claim 99, wherein the complex metal salt is provided in an amount of from about 2 to about 40 percent by weight, based on the total weight of the coagulant solution.

103. A system of claim 98, wherein the polyepiamine is provided in an amount of from 0.005 to about 1.0 percent by weight, based on the total weight of the wash water system.

104. The system of claim 65, wherein the coagulant includes an electrolyte/dialkylamine epihalohydrin.

105. The system of claim 104, wherein the electrolyte/dialkylamine epihalohydrin is a sodium chloride/dimethylamine epichlorohydrin.

106. A system of claim 104, wherein the electrolyte/dialkylamine epihalohydrin is provided in an amount of from 0.005 to 1.0 percent by weight, based on the total weight of the wash water system.

107. The system of claim 65, wherein the coagulant includes a halide/dialkylamine-epihalorohydrin-alkylenediamine polymer.

108. The system of claim 107, wherein the halide/dialkylamine-epihalorohydrin-alkylenediamine is a chloride/dimethylamine-epichlorohydrin-ethylenediamine polymer.

109. A system of claim 107, wherein the halide/dialkylamine-epihalorohydrin-alkylenediamine polymer is provided in an amount of from 0.005 to about 1.0 percent by weight, based on the total weight of the wash water system.

110. The system of claim 65, wherein the coagulant includes components selected from the group consisting of:
a) a dialkylaminoalkyl (meth)acrylate polymer;
b) a hexosan polymer;
c) a montmorillonite-containing clay;
d) a poly[oxyalkylene(dialkylimino)alkylene] polymer solution;
e) a epihalohydrin/dialkylamine polymer;
f) a polydiallydialkylammonium halide polymer;
g) a polyepiamine;
h) an electrolyte/dialkylamine epihalohydrin; and
i) a halide/dialkylamine-epihalohydrin-alkylenediamine polymer; and
mixtures thereof.

111. The system of claim 110, wherein the coagulant is a mixture of:
1) at least one of a) through i); and
2) chitosan.

112. The system of claim 110, wherein the dialkylaminoalkyl (meth)acrylate polymer is a dimethylaminoethyl methacrylate polymer.

113. The system of claim 110, wherein the coagulants of a), b), and g) include a complex metal salt selected from the group consisting of aluminum chlorohydrate, aluminum sulfate, zinc chloride, ferric chloride, calcium chloride, magnesium hydroxide, and mixtures thereof.

114. The system of claim 113, wherein the complex metal salt is provided in an amount of from about 2 to about 40 percent by weight, based on the total weight of the coagulant solution.

115. The system of claim 110, wherein the hexosan polymer is an amylopectin polymer.

116. The system of claim 110, wherein the montmorillonite-containing clay is bentonite clay.

117. The system of claim 116, wherein the bentonite clay is provided in an amount of from 1 to 25 percent by weight, based on the total weight of the coagulant solution.

118. The system of claim 110, wherein the poly[oxyalkylene(dialkylimino)alkylene] polymer solution is a poly[oxyethylene(dimethylimino)ethylene] polymer solution.

119. The system of claim 110, wherein the epihalohydrin/dialkylamine polymer is a epichlorohydrin/dimethylamine polymer.

120. The system of claim 110, wherein the polydiallydialkylammonium halide polymer is a polydiallydimethylammonium chloride polymer.

121. The system of claim 110, wherein the electrolyte/dialkylamine epihalohydrin is a sodium chloride/dimethylamine epichlorohydrin.

122. The system of claim 110, wherein the halide/dialkylamine-epihalohydrin-alkylenediamine is a chloride/dimethylamine-epichlorohydrin-ethylenediamine polymer.

123. The system of claim 110, further comprising an agitated organic solvents component, the organic solvents component being characterized as having a solubility in water of less than 15 percent by weight and in which water is soluble in the organic solvent component to an extent of less than 15 percent by weight, the percentages by weight being based on weight of organic solvent component and water.

124. The system of claim 123, wherein the system is stable in the presence of agitation but unstable in the absence of agitation.

125. The system of claim 123, wherein the organic solvent component has a solubility in water of 1 to 5 percent by weight.

126. The system of claim 123, wherein water has a solubility in the organic solvent component to an extent of 1 to 5 percent by weight.

127. The system of claim 123, wherein the organic solvent component has a vapor pressure less than 0.1 mm mercury.

128. The system of claim 123, wherein the organic solvent component has a specific gravity of 0.90 to 0.95 or 1.05 to 1.10.

129. The system of claim 123, wherein the organic solvent component in water is agitated by the pumping and circulating action of the solution in a water wash spray booth.

130. The system of claim 123, wherein the organic solvent component is present in the solution in amounts of 2 to 50 percent by weight based on weight of water and organic solvent component.

131. The system of claim 130, wherein the organic solvent component is present in the solution in amounts of 15 to 25 percent by weight based on weight of water and organic solvent component.

132. The system of claim 123, wherein the organic solvent component contains a dialkyl ester of a dibasic acid having the following structure: 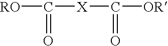
where R and R′ are the same or different and are alkyl groups containing from 1 to 6 carbon atoms, and X is an alkylene group containing from 2 to 12 carbon atoms or a mixture of such esters.

133. The system of claim 132, wherein the dialkyl ester of a dibasic acid is selected from the group consisting of dimethyl adipate, dimethyl glutarate, dimethyl succinate and mixtures thereof.

134. The system of claim 123, wherein the organic solvent component contains a glycol ether or mixture of glycol ethers.

135. The system of claim 65, wherein the solution comprises a liquid concentrate for addition to water systems for use in paint spray booths.

136. A wash water system for treating paint overspray in paint spray booths, the system comprising:
a coagulant in amounts ranging from 0.005 to 1.0 percent by weight, based on the total weight of the system;
an agitated organic solvents component; and
water.

137. The system of claim 136, wherein the coagulant includes components selected from the group consisting of:
a) a dialkylaminoalkyl (meth)acrylate polymer;
b) a hexosan polymer;
c) a montmorillonite-containing clay;
d) a poly[oxyalkylene(dialkylimino)alkylene] polymer solution;
e) a epihalohydrin/dialkylamine polymer;
f) a polydiallydialkylammonium halide polymer;
g) a polyepiamine;
h) an electrolyte/dialkylamine epihalohydrin; and
i) a halide/dialkylamine-epihalohydrin-alkylenediamine polymer; and
mixtures thereof.

138. The method of claim 137, wherein the coagulant is a mixture of:
1) at least one of a) through i); and
2) chitosan.

139. The system of claim 137, wherein the organic solvents component is characterized as having a solubility in water of less than 15 percent by weight and in which water is soluble in the organic solvent component to an extent of less than 15 percent by weight, the percentages by weight being based on weight of organic solvent component and water.

140. The system of claim 137, wherein the paint overspray is a waterborne paint.
